(19) United States
(12) Patent Application Publication
(10) Pub. No.: US 2013/0016766 A1
(43) Pub. Date: Jan. 17, 2013

(54) RECEIVING DEVICE

(71) Applicant: Nami Soma, Tokyo (JP)

(72) Inventor: Nami Soma, Tokyo (JP)

(73) Assignee: MITSUBISHI ELECTRIC CORPORATION, Tokyo (JP)

(21) Appl. No.: 13/637,747

(22) PCT Filed: Jul. 28, 2010
(86) PCT No.: PCT/JP2010/004788

§ 371 Date: Sep. 27, 2012

(51) Int. Cl. H04B 17/00

(52) U.S. Cl. 375/224

(57) ABSTRACT

A receiving device reduces a frequency of performing AF check per a predetermined amount of time during a reception of a digital broadcast through a hybrid broadcast to less than a frequency of performing AF check per a predetermined amount of time during a reception of an analog broadcast through the hybrid broadcast.

### TECHNICAL FIELD

The present invention relates to a receiving device which receives a digital radio broadcast such as a high definition (HD) radio broadcast.

### BACKGROUND ART

In Band On Channel (IBOC) system is a broadcast system capable of simultaneously implementing an analog broadcast and a digital broadcast by using the existing AM/FM frequency bands. This system was authorized by the Federal Communication Commission (FCC) in 2002, and has been recently increasingly spreading as the HD radio broadcast.

In a receiving device for Radio Data System (RDS) or Broadcast Data System (BDS) which are FM multiplex broadcast systems, an Alternative Frequency (AF) check is adopted. The AF check is an operation for examining reception qualities of alternative frequencies in order to find broadcast stations broadcasting identical contents in a better reception quality than that of the current received station when the reception status of the current received station deteriorates. When the alternative frequency has the better reception quality, the alternative frequency is continuously received. When the alternative frequency has worse reception quality, the original frequency is received.

Patent Literature 1 discloses an example of a conventional receiving device for receiving a broadcast wave in the IBOC system. This device includes a diversity receiving unit to control a diversity switching part to be in an enabled state and to select an output of a narrow-band filter when determining that the received broadcast wave does not include IBOC broadcast wave. On the other hand, when the diversity receiving unit determines that the received broadcast wave includes IBOC broadcast wave, the diversity switching part is controlled to be in a disenabled state and to select an output of a wide-band filter. According to those controls, the reception status of IBOC broadcast and the analog broadcast are optimized.

The conventional receiving device typified by Patent Literature 1, however, has a problem in that, if an alternative frequency is received even for a short time by performing AF check during reception of a digital broadcast, a “synchronization loss” may occur at a timing when acquiring digital data while the alternative frequency is switched to the current received station that has received the digital broadcast. This situation sometimes causes deterioration of the performance of receiving the digital broadcast.

The present invention is made to solve the problem mentioned above, and an object thereof is to acquire a receiving device capable of preventing a reception of digital broadcast from a synchronization loss caused by AF check.

### CITATION LIST

### Patent Literature

Patent Literature 1

Japanese Patent Application Laid-Open (JP-A) No. 2004-349805

### SUMMARY OF THE INVENTION

A receiving device according to the present invention, which receives a hybrid broadcast containing an analog broadcast and a digital broadcast, and performs an alternative frequency (AF) check for examining frequency of broadcast stations broadcasting identical contents to receive a broadcast wave in a good reception status, includes: a control unit configured to reduce a frequency of performing the AF check per a predetermined amount of time during a reception of the digital broadcast through the hybrid broadcast to less than a frequency of performing the AF check per a predetermined amount of time during a reception of the analog broadcast through the hybrid broadcast.

According to the present invention, the receiving device reduces a frequency of performing AF check per a predetermined amount of time during a reception of a digital broadcast through a hybrid broadcast to less than a frequency of performing AF check per a predetermined amount of time during a reception of an analog broadcast through the hybrid broadcast. This can prevent a reception of digital broadcast from a synchronization loss caused by AF check.

### BRIEF DESCRIPTION OF THE DRAWINGS

FIG. 1 is a view showing a configuration of a broadcast wave transmission in an FM hybrid system.

FIG. 2 is an explanatory view showing a switching between an analog sound and a digital sound.

FIG. 3 is a view showing the relationships between the sound qualities and the reception qualities of a digital sound and an analog sound in the FM hybrid system.

FIG. 4 is a block diagram for showing a structure of a receiving device according to Embodiment 1 of the present invention.

FIG. 5 is a flowchart showing an operation (Method 1) by a HD radio receiver according to Embodiment 1.

FIG. 6 is a flowchart showing an operation (Method 2) by the HD radio receiver according to Embodiment 1.

FIG. 7 is a flowchart showing an operation (Method 3) by the HD radio receiver according to Embodiment 1.

FIG. 8 is a flowchart showing an operation (Method 4) by the HD radio receiver according to Embodiment 1.

FIG. 9 is a flowchart showing an operation (Method 5) by the HD radio receiver according to Embodiment 1.

### DESCRIPTION OF EMBODIMENTS

An embodiment of the present invention will be described with reference to the appended drawings in order to describe the present invention in detail.

### Embodiment 1

There is an FM hybrid system as one of transmission systems of Digital broadcast wave.

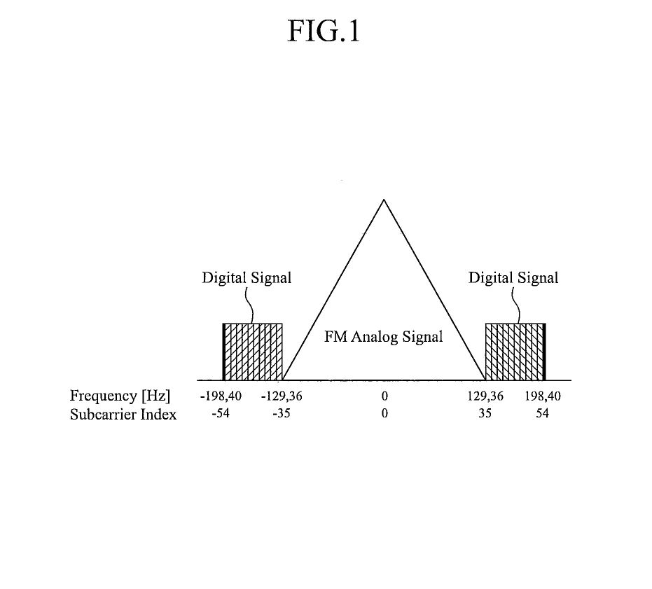

FIG. 1 is a view for showing a configuration of a broadcast wave transmission in the FM hybrid system. As shown in FIG. 1, in the digital broadcast transmission using the FM hybrid system, a new allocation of frequency band is not required because the same frequency band as that in conventional analog FM/AM broadcasts is used. Note that the FM hybrid system is a combined analog/digital system in which digital modulated wave having around 70 kHz band is added at each of the upper side band and the lower side band of the FM analog signal.

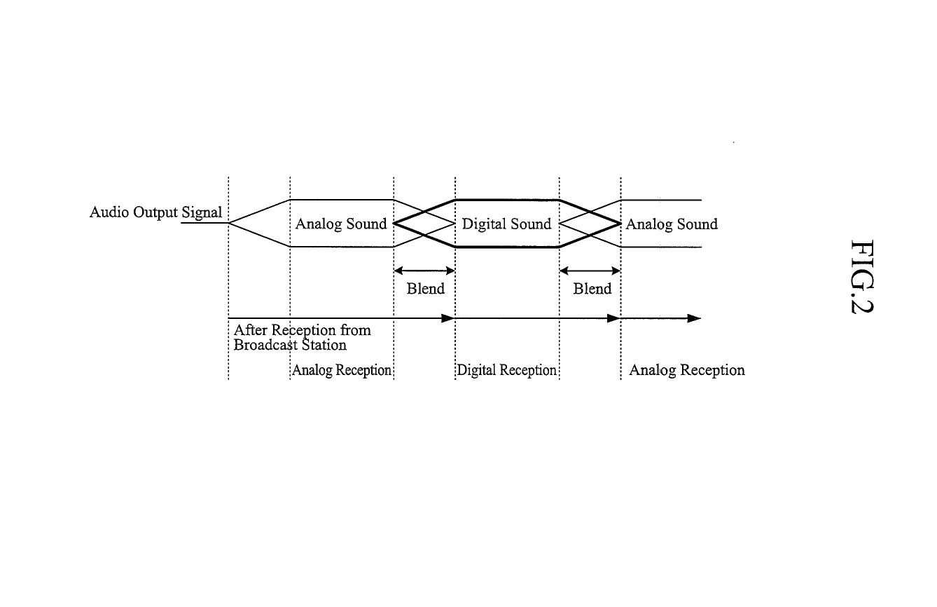

In an HD radio receiver which receives the digital broadcast transmitted by using the above-mentioned FM hybrid system, an analog broadcast is first received from the broadcast station as shown in FIG. 2. The digital broadcast wave is demodulated when detecting a digital modulated wave, and then an analog output is switched with a digital output by a blend process.

In other words, the digital broadcast is received in an intensive or middle electric field area where the digital broadcast can be received, whereas, in order to prevent a sound interruption, the digital broadcast reception is smoothly switched to the analog broadcast reception in a weak electric field area where the digital broadcast cannot be received.

In the HD radio receiver, when receiving the digital broadcast, it is necessary to demodulate digital data with performing a synchronization using a clock which supplies a timing to acquire the digital data. If an alternative frequency is received even for a short time by performing AF check during a reception of the digital broadcast, a synchronization loss occurs in the demodulation process when the current received station is switched with a previous received station from which the HD radio receiver received the digital broadcast before receiving the alternative frequency. This situation causes deterioration of the performance of receiving the digital broadcast.

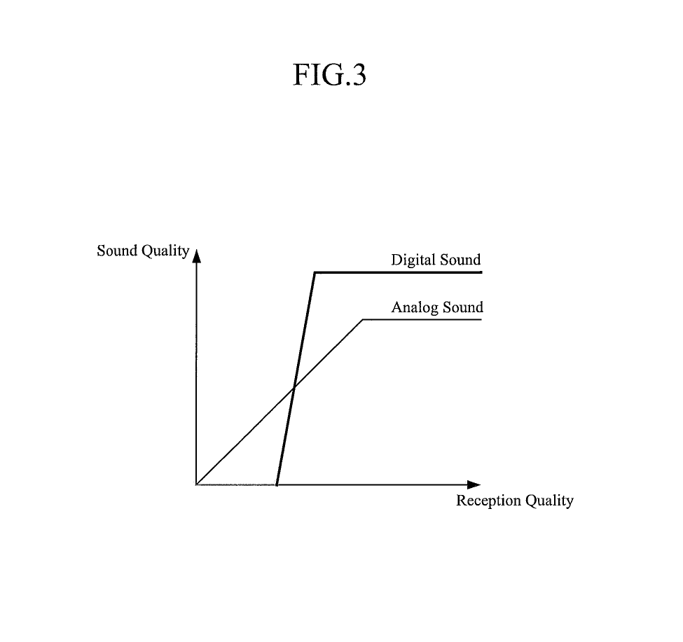

FIG. 3 is a view for showing relationships between sound qualities and reception qualities of both digital sound and analog sound in the FM hybrid system. As shown in FIG. 3, the sound quality becomes “zero” because a digital sound is not output at the HD radio receiver in a weak electric field area where a digital broadcast cannot be received. When the electric field reaches a predetermined intensity where the digital broadcast can be received, the sound achieves a high quality having CD-quality sound at a stroke.

With regard to an analog broadcast, as the reception quality increases, the sound quality mildly increases. When the sound reaches a predetermined quality, the sound quality stops increasing and does not become as good as that of the digital sound.

Furthermore, the analog sound is susceptible to phenomenon of a multipath and a fading phenomenon. The multipath is a phenomenon where delayed wave of the same radio wave are received from a plurality of paths. The fading is phenomenon where signal strength of a signal widely varies temporally and spatially. Thus, it is desirable for a user to maintain the reception of a digital broadcast having a high sound quality as long as possible.

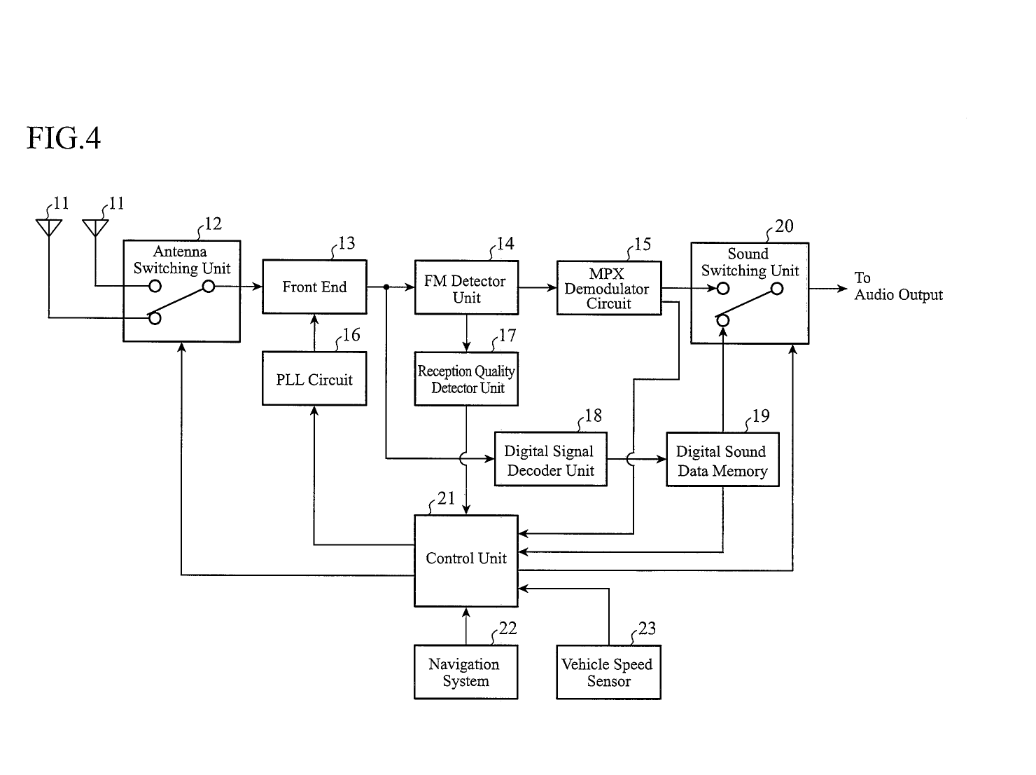

FIG. 4 is a block diagram for showing the structure of a receiving device according to Embodiment 1 of the present invention. The structure denotes that the present invention is applied to the HD radio receiver. The HD radio receiver shown in FIG. 4 includes an antenna 11, an antenna switching unit 12, a front end 13, an FM detector unit 14, a multiplexer (MPX) demodulator circuit 15, a phase locked loop (PLL) circuit 16, a reception quality detector unit 17, a digital signal decoder unit 18, a digital sound data memory 19, a sound switching unit 20, and a control unit 21. Note that the HD radio receiver is provided on a mobile object such as a vehicle. Hereinafter, the HD radio receiver which is provided on a vehicle having a navigation system 22 and a vehicle speed sensor 23 will be described.

An FM HD radio broadcast wave received by the antenna 11 is transmitted to the front end 13 through the antenna switching unit 12. The front end 13 selects a signal having a frequency of a desired broadcast station from the received broadcast wave, and converts the selected signal into an intermediate frequency (IF). After that, the converted signal is supplied to the FM detector unit 14 and the digital signal decoder unit 18.

The front end 13 is controlled by the PLL circuit 16 including a programmable divider. The control unit 21 sets division ratio to the PLL circuit 16, and selects a broadcast station. The detected output from the FM detector unit 14 is supplied to the MPX demodulator circuit 15. In stereo broadcasting, the output is separated into signals of left (L) and right (R) channels and are output to the sound switching unit 20 as analog sound data.

The digital signal decoder unit 18 acquires the digital data, which has been converted into intermediate frequencies, at predetermined timings synchronized with an operation clock, and decodes (demodulate) the acquired data. The sound data decoded by the digital signal decoder unit 18 is temporarily stored in the digital sound data memory 19, and then is output to the sound switching unit 20 as digital sound data. The control unit 21 monitors usage of the digital sound data memory. When the digital broadcast can be output, the control unit 21 instructs the sound switching unit 20 to select the digital sound to be output from the digital sound data memory 19. On the other hand, when the digital sound cannot be output, the control unit 21 instructs the sound switching unit 20 to select the analog sound to be output from the MPX demodulator circuit 15.

A frequency (i.e. number of times per second) of performing AF checks and an AF check starting threshold are set in the control unit 21. The AF check starting threshold relates to a parameter that defines a reception quality such as intensity of reception electric field for starting the AF check. The control unit 21 has this threshold as a condition for starting the AF check. When determining that the condition for starting AF check is satisfied in accordance with the comparison result between the parameter value detected by the reception quality detector unit 17 and the AF check starting threshold, the control unit 21 performs the AF check based on an AF list. The AF checklist is acquired from the broadcast wave of the current received station by the MPX demodulator circuit 15.

Note that the AF list is a list indicating frequencies (i.e. alternative frequencies) of the broadcast stations which are broadcasting the same broadcast content (or program) as the current received station.

Next, the operation of the receiving device according to Embodiment 1 will be described.

Methods 1 to 5 will be described in detail below. These Methods are for switching AF check control in accordance with the reception status of the broadcast station.

(Method 1) Method for Reducing Frequency of Performing AF Checks During Reception of a Digital Broadcast

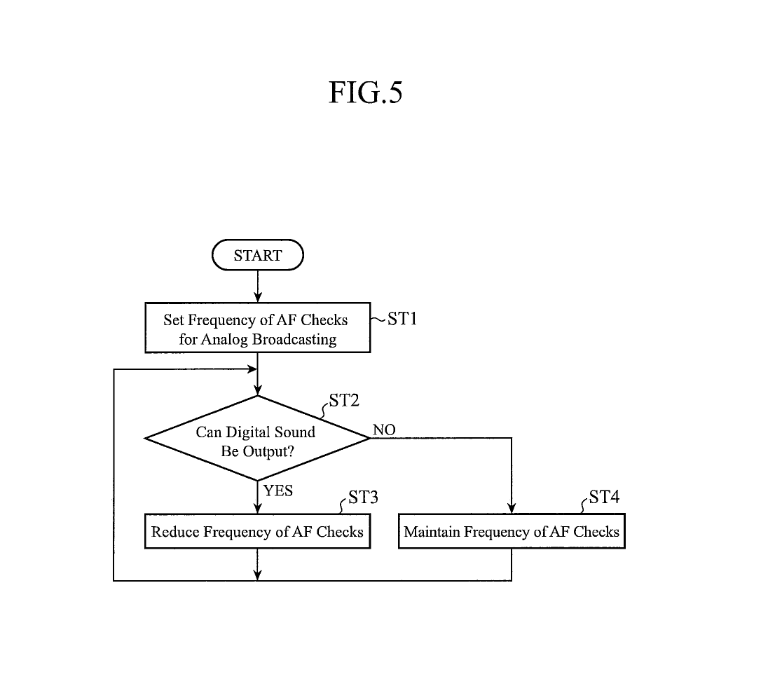

FIG. 5 is a flowchart showing an operation (Method 1) by the HD radio receiver according to Embodiment 1. As described above, an analog broadcast is necessarily received first at the start of the reception of a broadcast in the HD radio receiver. At that time, the control unit 21 sets a frequency (i.e. number of times per second) of performing the AF checks as a default value used in a reception of the analog broadcast (step ST1).

Next, the control unit 21 determines, based on the reception quality level detected by the reception quality detector unit 17, whether a digital broadcast can be received in the HD radio broadcast, in other words, whether a digital sound in the received HD radio broadcast can be output (step ST2). In other words, the digital sound output becomes “zero” at a reception quality level where the digital broadcast cannot be received. The digital sound is output at a reception quality level where the digital broadcast can be received.

When determining that the digital sound can be output (YES in step ST2), the control unit 21 reduces the frequency of AF checks from the current frequency (step ST3). The frequency of AF checks is reduced to a value where an effect by the reduction of the frequency can sufficiently be expected. For example, the current frequency can be reduced by half of the current frequency or completely reduced to zero. The target value for reducing the frequency of AF checks is set in the control unit 21 in advance.

On the other hand, when determining that the digital sound cannot be output (NO in step ST2), the control unit 21 maintains the current frequency of AF checks (step ST4). Instead of maintaining the current frequency, the current frequency of AF checks can be increased when the digital sound cannot be output.

Note that not only the frequency of AF checks is changed in accordance with whether the digital sound can be output, but also the frequency of AF checks can be more minutely set in consideration of effect of the reception quality (e.g. a reception electric field value, a multipath, an adjacent interference or the like).

For example, an equation is set in the control unit 21. The equation is for calculating an optimal value (i.e. a value determined experimentally and statistically) of the frequency of AF checks by using a parameter which defines a reception quality such as a reception electric field value, a multipath, and an adjacent interference. The control unit 21 calculates the optimal value by using the equation and the above-mentioned parameter which is acquired from the reception quality detected by the reception quality detector unit 17 while the digital broadcast is received. Thus the control unit 21 sets the calculated value as the frequency of AF checks.

In both of the reception of an analog broadcast and the reception of a digital broadcast, the AF check is performed at a time when the condition for starting the AF check is satisfied. For example, the threshold is set as the condition for starting the AF check in the control unit 21. This threshold relates to a reception quality level according to a reception electric field value, a multipath, an adjacent interference or the like. The control unit 21 compares the reception quality level with the above-mentioned threshold while the analog broadcast or the digital broadcast is received. The reception quality level has been led by a result detected by the reception quality detector unit 17. When the reception quality level of the current received station becomes less than the threshold and it is determined that the condition for starting the AF check is satisfied, the AF check is performed.

(Method 2) Method for Reducing a Value of the AF Check Starting Threshold During Reception of a Digital Broadcast

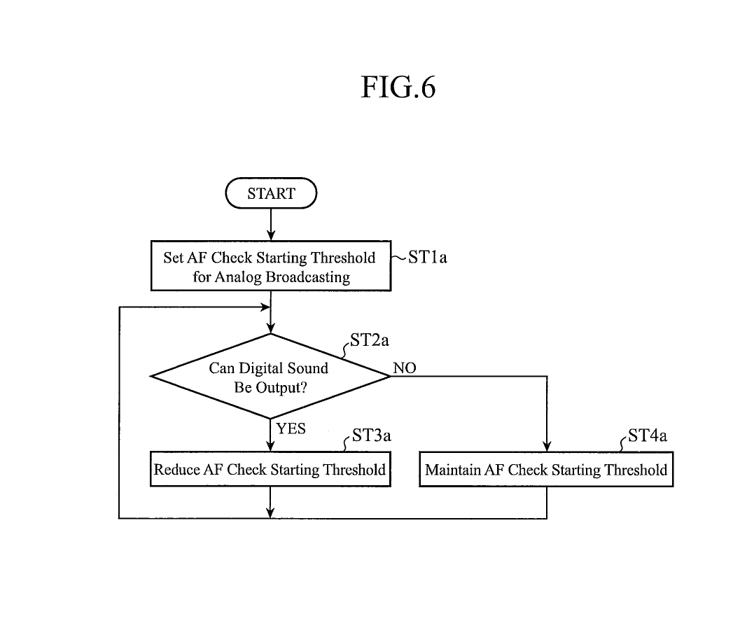

FIG. 6 is a flowchart showing an operation (Method 2) by the HD radio receiver according to Embodiment 1. As described above, an analog broadcast is necessarily received first at the start of the reception of a broadcast in the HD radio receiver. At that time, the control unit 21 sets a value of the AF check starting threshold as a default value used in a reception of the analog broadcast (step ST1a).

The AF check starting threshold relates to, for example, a reception quality level according to a reception electric field value, a multipath, and an adjacent interference. When the reception quality level is reduced to a level less than the AF check starting threshold, the AF check is started.

The control unit 21 determines in the same manner as the Method 1 whether the digital sound in the received HD radio broadcast can be output (step ST2a). When determining that the digital sound can be output (YES in step ST2a), the control unit 21 reduces a value of the AF check starting threshold from the current value (step ST3a). The AF check starting threshold is reduced to a value where the reception is at a level where it is not necessary to perform AF check. The target value for reducing the AF check starting threshold is set in the control unit 21 in advance.

On the other hand, when determining that the digital sound cannot be output (NO in step ST2a), the control unit 21 maintains the current value of AF check starting threshold (step ST4a). Instead of maintaining the current value, the AF check starting threshold can be increased from the current value when the digital sound cannot be output and the analog sound is continuously output for a while.

Note that not only the AF check starting threshold is changed in accordance with whether the digital sound can be output, but also the AF check starting threshold can be more minutely set inconsideration of the effect of the reception quality (e.g. a reception electric field value, a multipath, an adjacent interference or the like).

For example, an equation is set in the control unit 21. The equation is for calculating an optimal value (i.e. a value determined experimentally and statistically) of the AF check starting threshold by using a parameter that defines the reception quality such as a reception electric field value, a multipath, and an adjacent interference. The control unit 21 calculates an optimal value by using the equation and the above-mentioned parameter which is acquired from the reception quality detected by the reception quality detector unit 17 while the digital broadcast is received. Thus the control unit 21 sets the calculated value as the AF check starting threshold.

In both of the reception of an analog broadcast and the reception of a digital broadcast, the AF check is performed at a time when the condition for starting the AF check is satisfied. For example, the threshold is set as the condition for starting the AF check in the control unit 21. This threshold relates to a reception quality level according to a reception electric field value, a multipath, an adjacent interference or the like. The control unit 21 compares the reception quality level with the above-mentioned threshold while the analog broadcast or the digital broadcast is received. The reception quality level has been led by the result detected by the reception quality detector unit 17. When the reception quality level of the current received station becomes less than the threshold and it is determined that the condition for starting the AF check is satisfied, the AF check is performed.

(Method 3) Method for Controlling AF Check by Using a Rate of Digital Broadcast Station in AF Stations

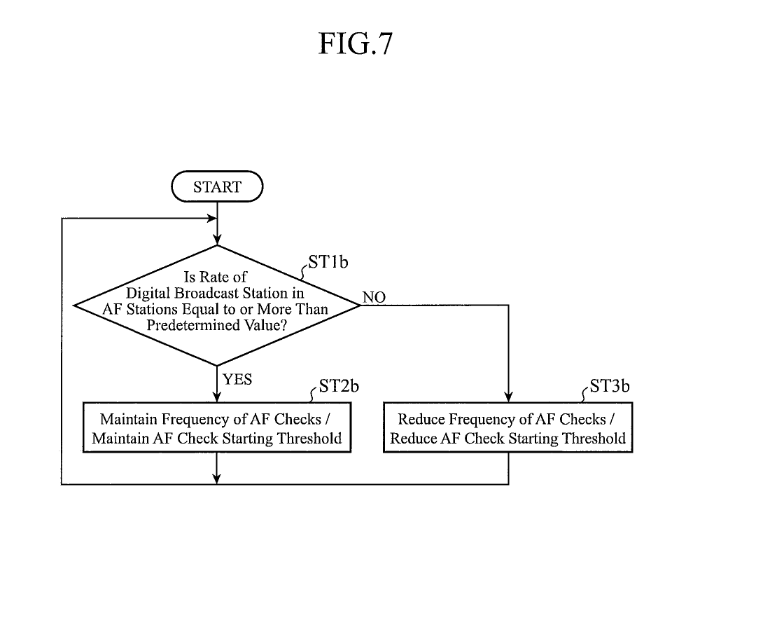

FIG. 7 is a flowchart for showing an operation (Method 3) by the HD radio receiver according to Embodiment 1. In the HD radio receiver, the control unit 21 acquires, from the navigation system 22, position information of a vehicle equipped with the HD radio receiver itself. The control unit 21 acquires, from the MPX demodulator circuit 15, information about digital broadcast stations in an area where the vehicle is located, that is, a whole AF list for the current received station in the current area. The current area is specified by the position information. The control unit 21 calculates the rate of digital broadcast station, and determines whether the calculated rate is equal to or more than a predetermined standard value (step ST1b). The rate of digital broadcast station indicates a rate of digital broadcast stations against all broadcast stations corresponding to the AF list for the current received station.

When determining that the rate of digital broadcast station is equal to or more than the predetermined standard value (YES in step ST1b), the control unit 21 performs at least one of the following processes (step ST2b): maintaining the current frequency of performing AF checks (or increasing the frequency of performing AF checks from the current frequency); and maintaining the current AF check starting threshold (or increasing the current AF check starting threshold from the current threshold). The reason for performing those processes is that, AF check in this situation is not likely to bring a switch to an analog broadcast.

On the other hand, when determining that the rate of digital broadcast station is less than the predetermined standard value (NO in step ST1b), the control unit 21 performs at least one of the following processes (step ST3b): reducing a value of frequency of AF checks from the current value; and reducing a value of the AF check starting threshold from the current value. The reason for performing those processes is that, AF check in this situation is likely to bring a switch to an analog broadcast. The target value for reducing the frequency of AF checks or the AF check starting threshold is set in the control unit 21 in advance.

Note that not only the frequency of AF checks or the AF check starting threshold is changed in accordance with whether the rate of digital broadcast station in the AF stations is equal to or more than the predetermined standard value, but also the optimal values of the frequency of AF checks or the AF check starting threshold can be gradually set in accordance with the rate of digital broadcast station in the AF stations, and then the frequency of AF checks or the AF check starting threshold can be gradually or more minutely changed in accordance with the rate of digital broadcast station of AF stations.

(Method 4) Method for Controlling AF Check by Using Information of Vehicle Speed

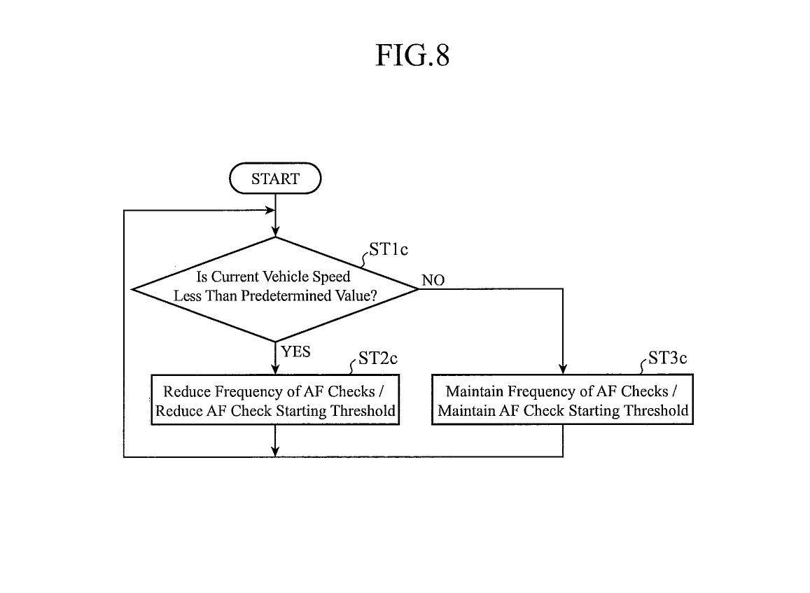

FIG. 8 is a flowchart for showing an operation (Method 4) by the HD radio receiver according to Embodiment 1. In the HD radio receiver, the control unit 21 first acquires, from the vehicle speed sensor 23, information of vehicle speed of a vehicle equipped with the HD radio receiver itself, and determines whether the current vehicle speed is less than a predetermined standard value (i.e. whether the speed is slower than a predetermined standard value) while the digital broadcast is received (step ST1c).

When determining that the vehicle speed is less than the predetermined standard value (YES in step ST1c), the control unit 21 performs at least one of the following processes (step ST2c): reducing a value of frequency of AF checks from the current value; and reducing a value of the AF check starting threshold from the current value. The reason for performing those processes is that, a mileage of the vehicle per a predetermined amount of time in this situation is getting short, and thereby the reception status of the broadcast station is less changed.

The frequency of AF checks or the AF check starting threshold is reduced as much as in the Methods 1 and 2. The target value for decreasing the frequency of AF checks or the AF check starting threshold is set in the control unit 21 in advance.

On the other hand, when determining that the vehicle speed is equal to or more than the predetermined standard value (NO in step ST1c), the control unit 21 performs at least one of the following processes (step ST3c): maintaining the current frequency of performing AF checks (or increasing the frequency of performing AF checks from the current frequency); and maintaining the current AF check starting threshold (or increasing the current AF check starting threshold from the current threshold). The reason for performing those processes is that, a mileage of the vehicle per a predetermined amount of time in this situation is getting long, and thereby the reception status of the broadcast station is widely changed.

Note that not only the frequency of AF checks or the AF check starting threshold is changed in accordance with whether the vehicle speed is less than the predetermined standard value, but also the frequency of AF checks can be more minutely set according to the value of the vehicle speed. Furthermore, while the vehicle stops, the AF check can be stopped because the reception status of the broadcast station is not changed.

(Method 5) Method Derived from a Combination of the Methods 1 to 4.

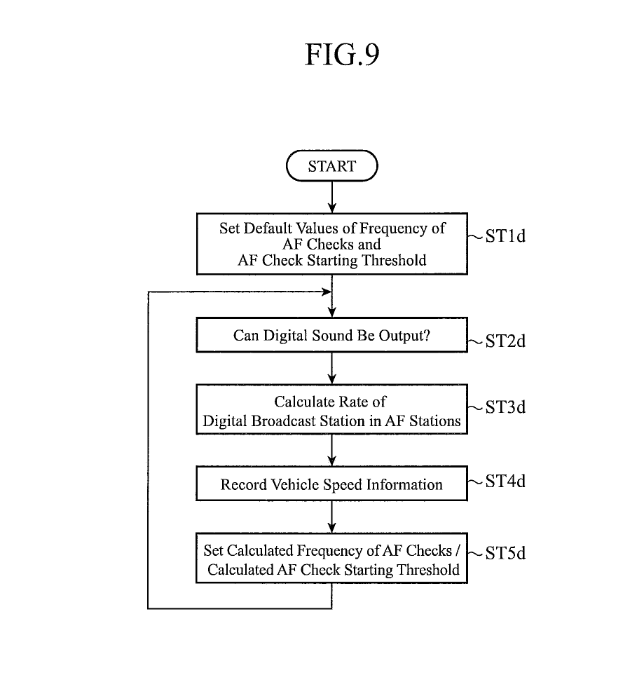

FIG. 9 is a flowchart for showing an operation (Method 5) by the HD radio receiver according to Embodiment 1. As described above, an analog broadcast is necessarily received first when the control unit 21 starts to receive a broadcast in the HD radio receiver. At that time, the control unit 21 sets the frequency of AF checks and the AF check starting threshold as default values during reception of the analog broadcast (step ST1d).

The control unit 21 determines whether the digital sound of the received HD radio broadcast can be output, and records the determination result in a memory (not shown in FIG. 4) having a work region for recording the information acquired by processes of the control unit 21 (step ST2d). The control unit 21 can record not only the determination result of whether the digital sound can be output, but also the detection result indicating the current reception quality (e.g. a reception electric field value, a multipath, an adjacent interference or the like) acquired by the reception quality detector unit 17.

The control unit 21 acquires, from the navigation system 22, position information of a vehicle equipped with the HD radio receiver itself. The control unit 21 acquires, from the MPX demodulator circuit 15, information about the digital broadcast stations in an area where the vehicle is located, that is, a whole AF list for the current received station in the current area. The current area is specified by the position information. The control unit 21 calculates the rate of digital broadcast station, and then records the calculated rate into the above-mentioned memory (step ST3d). The rate of digital broadcast station indicates a rate of digital broadcast stations against all broadcast stations corresponding to the AF list for the current received station.

During a receipt of digital broadcast, the control unit 21 acquires information of the current vehicle speed of the vehicle from the vehicle speed sensor 23, and records the acquired information into the above-mentioned memory (step ST4d).

In step ST5d, in consideration of the following information which are recorded into the above-mentioned memory, the control unit 21 controls the frequency of AF checks or the AF check starting threshold: whether the digital sound can be output in the current reception status; whether the rate of digital broadcast station is equal to or more than a predetermined standard value; or whether the vehicle speed during reception of the digital broadcast is less than a predetermined standard value.

Specifically, an equation is set in the control unit 21. The equation is for calculating optimal values (i.e. values determined experimentally and statistically) of the frequency of AF checks and the AF check starting threshold by using a parameter. The parameter represented in a digital value may indicates: whether the digital sound can be output in the current reception status; whether the rate of digital broadcast station is equal to or more than a predetermined standard value; or whether the vehicle speed during reception of the digital broadcast is less than a predetermined standard value.

When the process from step ST2d to step ST4d has been completed, the control unit 21 sets the optimal values as the frequency of AF checks and the AF check starting threshold. The optimal values have been calculated from the equation using the above-mentioned parameter recorded in the above-mentioned memory.

As described above, according to the Embodiment 1, the receiving device controls at least one of the frequency of AF checks and the AF check starting threshold to reduce the frequency of AF checks performed during reception of the digital broadcast by using at least one of the following information: the possibility of output of a digital sound (i.e. the possibility of reception of a digital broadcast), the rate of digital broadcast station in all AF stations for the current received station, and the vehicle speed information.

Those controls efficiently diminish a synchronization loss caused by performing AF check during reception of the digital broadcast.

### INDUSTRIAL APPLICABILITY

The receiving device according to the present invention can diminish a synchronization loss caused by performing AF check during reception of a digital broadcast and can reduce interruption of the digital sound. Therefore, the receiving device is preferably applied to a digital broadcast receiving device to be provided on a vehicle where the reception environment is possibly changed from moment to moment due to the travel motion of the vehicle.

1. A receiving device which receives a hybrid broadcast containing an analog broadcast and a digital broadcast, and performs an alternative frequency (AF) check for examining frequency of broadcast stations broadcasting identical contents to receive a broadcast wave in a good reception status, the receiving device comprising:
a control unit configured to reduce a frequency of performing the AF check per a predetermined amount of time during a reception of the digital broadcast through the hybrid broadcast to less than a frequency of performing the AF check per a predetermined amount of time during a reception of the analog broadcast through the hybrid broadcast.

2. A receiving device which receives a hybrid broadcast containing an analog broadcast and a digital broadcast, and performs an alternative frequency (AF) check for examining frequency of broadcast stations broadcasting identical contents to receive a broadcast wave in a good reception status, the receiving device comprising:
a control unit configured to reduce a threshold of reception quality level utilized for starting the AF check during a reception of the digital broadcast through the hybrid broadcast to less than a threshold of reception quality level utilized for starting the AF check during a reception of the analog broadcast through the hybrid broadcast.

3. A receiving device which receives a hybrid broadcast containing an analog broadcast and a digital broadcast, and performs an alternative frequency (AF) check for examining frequency of broadcast stations broadcasting identical contents to receive a broadcast wave in a good reception status, the receiving device comprising:
a control unit configured to vary, in accordance with a rate of digital broadcast station, a frequency of performing the AF check per a predetermined amount of time or a threshold of reception quality level utilized for starting the AF check to reduce a frequency of the AF check during a reception of the digital broadcast, the rate of digital broadcast station indicating a rate of digital broadcast stations against all switchable broadcast stations which broadcast identical contents through the hybrid broadcast being received by the receiving device.

4. (canceled)

5. A receiving device which receives a hybrid broadcast containing an analog broadcast and a digital broadcast, and performs an alternative frequency (AF) check for examining frequency of broadcast stations broadcasting identical contents to receive a broadcast wave in a good reception status, the receiving device comprising:
a control unit configured to vary a frequency of performing the AF check per a predetermined amount of time or a threshold of reception quality level utilized for starting the AF check to reduce a frequency of the AF check during a reception of the digital broadcast, said frequency or said threshold being varied in accordance with
a determination of whether to be able to receive the digital broadcast through the hybrid broadcast,
a rate of digital broadcast station indicating a rate of digital broadcast stations against all switchable broadcast stations which broadcast identical contents through the hybrid broadcast being received by the receiving device, and
a moving speed of a mobile object equipped with the receiving device.
